(19) United States
(12) Patent Application Publication
(10) Pub. No.: US 2023/0385712 A1
(43) Pub. Date: Nov. 30, 2023

(54) RESERVATION SUPPORT SYSTEM, RESERVATION SUPPORT METHOD, AND RECORDING MEDIUM

(71) Applicant: NEC Corporation, Tokyo (JP)

(72) Inventors: Yuto Nakaya, Tokyo (JP); Tasuku Yoshihiro, Tokyo (JP); Kei Shibukawa, Tokyo (JP); Mitsuyoshi Matsumoto, Tokyo (JP)

(73) Assignee: NEC Corporation, Tokyo (JP)

(21) Appl. No.: 18/122,237

(22) Filed: Mar. 16, 2023

(30) Foreign Application Priority Data
May 30, 2022 (JP) 2022-087775

(51) Int. Cl. G06Q 10/02; G06Q 10/1093

(52) U.S. Cl. CPC G06Q 10/02; G06Q 10/1093

(57) ABSTRACT

A reservation support method includes: acquiring a progress status of reading by a user for a book; specifying a recommended reservation time of a facility based on the progress status; presenting the specified recommended reservation time to the user; and accepting a reservation.

This application is based upon and claims the benefit of priority from Japanese Patent Application No. 2022-087775, filed on May 30, 2022, the disclosure of which is incorporated herein in its entirety by reference.

### TECHNICAL FIELD

The present disclosure relates to a reservation support system and the like.

### BACKGROUND ART

A user may reserve and use facilities. For example, Reference Literature 1 (WO 2016/098585 A1) describes selecting a start time of a reservation-available time zone from a terminal of a customer in order to reserve a beauty salon. For example, Reference Literature 2 (JP 2022 041298 A) describes determining a read range of a target book.

### SUMMARY

A reservation support system according to an aspect of the present disclosure includes: an acquisition means configured to acquire a progress status of reading by a user for a book; a specification means configured to specify a recommended reservation time of a facility based on the progress status; an output control means configured to present the specified recommended reservation time to the user; and an accepting means configured to accept a reservation.

A reservation support method according to one aspect of the present disclosure includes: acquiring a progress status of reading by a user for a book; specifying a recommended reservation time of a facility based on the progress status; presenting the specified recommended reservation time to the user; and accepting a reservation.

A program according to one aspect of the present disclosure causes a computer to execute: acquiring a progress status of reading by a user for a book; specifying a recommended reservation time of a facility based on the progress status; presenting the specified recommended reservation time to the user; and accepting a reservation.

The program may be stored in a non-transitory computer-readable recording medium.

According to the present disclosure, it is possible to facilitate determination of reservation of a facility by a customer.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration example of a reservation support system according to a first example embodiment;

FIG. 2 is a flowchart illustrating an operation example of the reservation support system according to the first example embodiment;

FIG. 3 is an explanatory diagram illustrating an example of connection between the reservation support system and another device;

FIG. 4 is a block diagram illustrating a configuration example of a reservation support system according to a second example embodiment;

FIG. 5 is an explanatory diagram illustrating an example of a screen for receiving a progress status of reading of a book;

FIG. 6 is an explanatory diagram illustrating an example in which recommended reservation time and candidates for reservation date are presented and reservation date and reservation time are accepted;

FIG. 7 is an explanatory diagram illustrating an example of presentation of a recommended reservation time, recommended reservation days, and a plurality of candidates for reservation dates;

FIG. 8 is an explanatory diagram illustrating an example of presentation of a reservation-available time zone of a reservation date selected from a plurality of candidates for reservation dates;

FIG. 9 is a flowchart illustrating an operation example of the reservation support system according to the second example embodiment; and

FIG. 10 is an explanatory diagram illustrating an exemplary hardware configuration of a computer.

### EXAMPLE EMBODIMENT

Hereinafter, example embodiments of a reservation support system, a reservation support method, a program, and a non-transitory recording medium recording the program according to the present disclosure will be described in detail with reference to the drawings. The present example embodiment does not limit the disclosed technology.

For example, when the user reserves a facility, the reservation is made depending on availability of the facility reservation. However, it may be difficult for the user to determine a reservation. For example, there is a case where it is difficult to know how long the reservation is required to finish reading a book.

An object of the present disclosure is to provide a reservation support system and the like that facilitates reservation of a facility by a user.

### First Example Embodiment

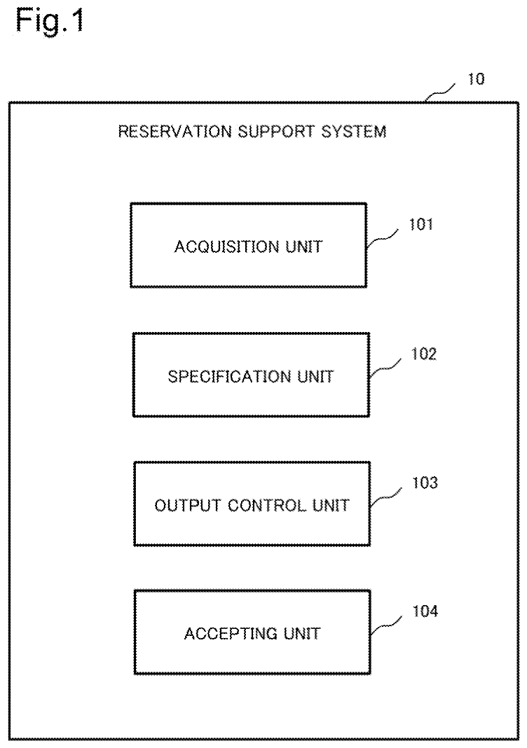

First, in a first example embodiment, a basic function of a reservation support system will be described. FIG. 1 is a block diagram illustrating a configuration example of a reservation support system 10 according to the first example embodiment. The reservation support system 10 includes an acquisition unit 101, a specification unit 102, an output control unit 103, and an accepting unit 104.

The acquisition unit 101 acquires the progress status of reading for the book by the user. the progress status of reading is, for example, the remaining number of pages on which the user reads the book. The remaining number of pages can be specified from the number of pages currently read and the total number of pages of the book. Therefore, the progress status may be, for example, a page currently read. The page currently read by the user is also referred to as a current page, and the number of pages currently read by the user is also referred to as a current number of pages. The user here is a person who reserves and uses a facility. The facility here is a facility that allows reading. For example, the facility may be a store such as a cafe or a public facility, and is not particularly limited. For example, in a case where the facility is a store, the user is a customer.

Specifically, for example, the acquisition unit 101 may acquire the progress status of reading from a database or the like. For example, the database may be a database that stores the progress status of specified reading. The progress status of reading may be specified by an IoT (Internet of Things) device. The IoT device may be a booklet-type IoT device. For example, the IoT device may specify the thickness of one side of the book when the book is sandwiched, and may specify the number of pages currently read by the user based on the thickness of one page and the thickness of one side. The IoT device may specify the current number of pages as the progress status of reading from the image of the current page in the book.

Alternatively, in a case where the book is an electronic book, the acquisition unit 101 may acquire the progress status of reading from an application program that manages the electronic book.

Alternatively, for example, the acquisition unit 101 may acquire the progress status of reading by receiving an input by the user. For example, the acquisition unit 101 may receive an input of a specific current number of pages or a specific remaining number of pages by a user's operation via a terminal device.

Alternatively, for example, the acquisition unit 101 may acquire an image of the current page imaged by the imaging device, and extract the current number of pages from the image of the current page, thereby acquiring the current number of pages as the progress status of reading. The imaging device may be provided in the terminal device of the user or may be provided by an IoT device, and is not particularly limited. As a method of acquiring the image of the current page, in a case where the imaging device is provided in the terminal device of the user, the acquisition unit 101 may acquire the image of the current page captured by the operation of the user via the terminal device, for example.

The specification unit 102 specifies the recommended reservation time of the facility based on the progress status of reading.

As a specific method of specifying the recommended reservation time of the facility, for example, in a case where the progress status of reading includes the remaining number of pages, the specification unit 102 specifies the reading finish time based on the remaining number of pages. The specification unit 102 may specify the recommended reservation time of the facility based on the reading finish time. In a case where the current number of pages is included as the progress status of reading, for example, the specification unit 102 specifies the remaining number of pages based on the total number of pages of the book and the current number of pages. Then, the specification unit 102 specifies the reading finish time based on the specified remaining number of pages.

Here, as a method of specifying the reading finish time, for example, the reading finish time may be determined in advance for each number of pages, and the specification unit 102 may specify the reading finish time related to the remaining number of pages. Alternatively, the specification unit 102 may specify the reading finish time based on the remaining number of pages and the reading speed. The reading speed will be described in detail with reference to the second example embodiment.

Next, as a specific method of specifying the recommended reservation time based on the reading finish time, for example, the specification unit 102 may specify the reading finish time as the recommended reservation time of the facility. Alternatively, for example, the specification unit 102 may specify a time obtained by adding a predetermined time to the reading finish time as the recommended reservation time of the facility. The predetermined time is a time required for other than reading in the facility, such as a time for eating and drinking.

The output control unit 103 presents the specified recommended reservation time to the user. Specifically, for example, the output control unit 103 presents the recommended reservation time to the user via the terminal device. The terminal device may be a device of the user or a device of the facility. More specifically, for example, the output control unit 103 causes the output device of the terminal device to output the recommended reservation time. When the output device is a display device, the output control unit 103 causes the display device of the terminal device to display the recommended reservation time. In a case where the output device is a voice output device, the output control unit 103 causes the display device of the terminal device to output the recommended reservation time by voice.

The accepting unit 104 accepts a reservation. The reservation here includes, for example, at least a reservation time. The reservation time may be a time such as two hours, or may be a reservation time zone such as from 12:00 to 14:00. Specifically, for example, the accepting unit 104 may accept a reservation including the recommended reservation time as the reservation time. Alternatively, for example, when a plurality of recommended reservation times are specified, the accepting unit 104 may accept a reservation including a recommended reservation time selected by the user from the plurality of recommended reservation times as the reservation time. If the user senses that the recommended reservation time is short when confirming the recommended reservation time, the user may want to set a time longer than the recommended reservation time as the reservation time. On the other hand, if the user feels that the recommended reservation time is long, the user may want to set a time shorter than the recommended reservation time as the reservation time. Therefore, for example, the accepting unit 104 may accept a reservation including a time added or subtracted by the user from the recommended reservation time as the reservation time. Alternatively, for example, the accepting unit 104 may accept a reservation including a reservation time input by a user's operation.

The reservation may include a reservation date. The accepting unit 104 may accept the reservation time and the reservation date at the same timing or at different timings. For example, before presenting the recommended reservation time, the accepting unit 104 may accept the reservation date prior to the reservation time.

For example, as a method of accepting a reservation, the accepting unit 104 may accept a reservation via the terminal device. As an example of accepting the reservation via the terminal device, the accepting unit 104 accepts the reservation by the user's operation on the terminal device. The user may be a worker of the facility or a user. In a case where the facility is a store, the worker is, for example, a salesclerk.

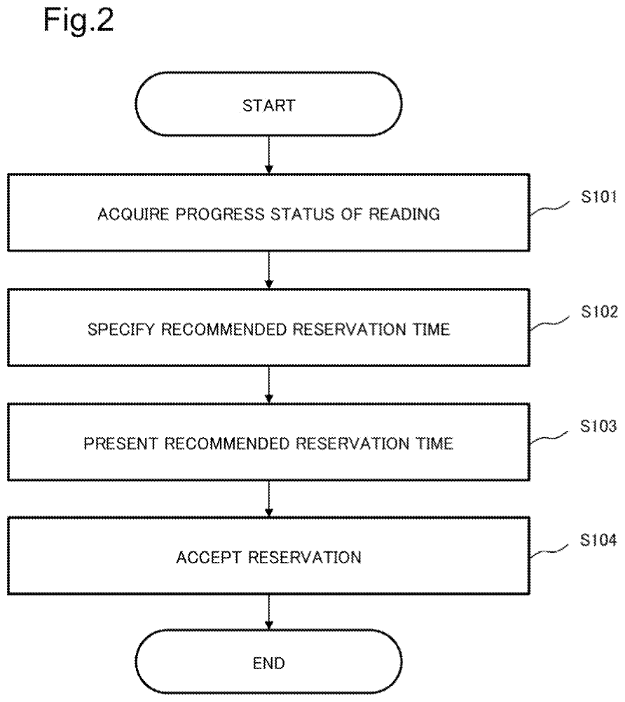

FIG. 2 is a flowchart illustrating an operation example of the reservation support system 10 according to the first example embodiment. The acquisition unit 101 acquires the progress status of reading (step S101). The specification unit 102 specifies the recommended reservation time (step S102). The output control unit 103 presents the recommended reservation time (step S103). The accepting unit 104 accepts a reservation (step S104).

As described above, in the first example embodiment, the reservation support system 10 specifies and presents the recommended reservation time based on the progress status of reading, and accepts the reservation. Accordingly, the recommended reservation time related to the progress status of reading is recommended. Therefore, the customer can reserve the facility while confirming the recommended reservation time. Therefore, it is possible to facilitate determination of reservation by the customer. For example, the progress status includes the remaining number of pages of reading.

The reservation support system 10 specifies the reading finish time of the book based on the progress status and the reading speed, and specifies the recommended reservation time based on the reading finish time. Accordingly, the customer can make a reservation suitable for finishing reading for the book.

### Second Example Embodiment

Hereinafter, a second example embodiment will be described in detail with reference to the drawings. In the second example embodiment, an example of specifying a candidate for a scheduled date and a recommended reservation time will be described. In the second example embodiment, a store will be described as an example of a facility, and a customer will be described as an example of a user. Hereinafter, description of contents overlapping with the above description will be omitted to the extent that the description of the second example embodiment is not unclear.

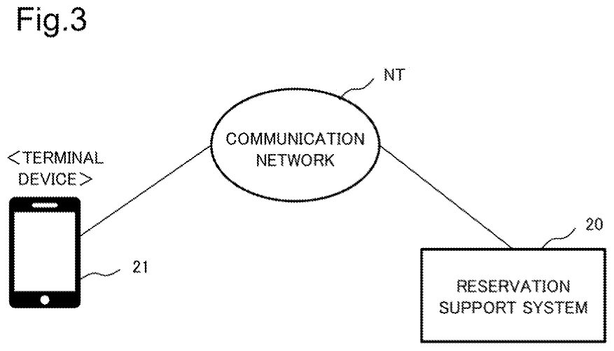

FIG. 3 is an explanatory diagram illustrating an example of connection between the reservation support system and another device. For example, the reservation support system 20 is connected to the terminal device 21 and the like via a communication network NT. In FIG. 3, the number of terminal devices 21 is not particularly limited. The type of the terminal device 21 is not particularly limited as in a smartphone, a tablet-type device, and a personal computer (PC).

For example, an application program capable of accepting a scheduled date and a scheduled time for reservation of a store may be installed in the terminal device 21 in advance.

In FIG. 3, one communication network NT is exemplified for ease of description, but the reservation support system 20 may be connected by different communication networks NT for the terminal devices 21, and is not particularly limited.

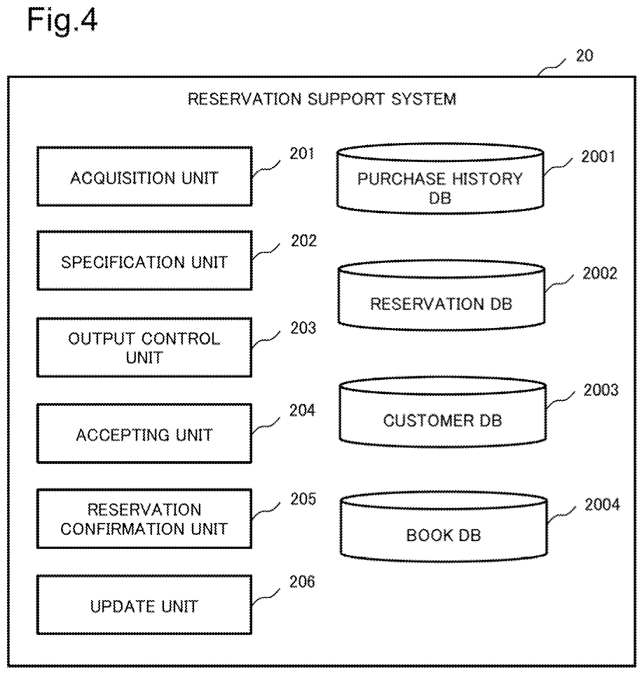

FIG. 4 is a block diagram illustrating a configuration example of a reservation support system 20 according to the second example embodiment. The reservation support system 20 includes an acquisition unit 201, a specification unit 202, an output control unit 203, an accepting unit 204, a reservation confirmation unit 205, and an update unit 206.

In reservation support system 20 according to the second example embodiment, the reservation confirmation unit 205 and the update unit 206 are added to the reservation support system 10 according to the first example embodiment. The acquisition unit 201 has the function of the acquisition unit 101 according to the first example embodiment as a basic function. The specification unit 202 has the function of the specification unit 102 according to the first example embodiment as a basic function. The output control unit 203 has the function of the output control unit 103 according to the first example embodiment as a basic function. The accepting unit 204 has the function of the accepting unit 104 according to the first example embodiment as a basic function.

The reservation support system 20 includes a purchase history DB (Database) 2001, a reservation DB 2002, a customer DB 2003, and a book DB 2004.

The purchase history DB 2001 stores a purchase history of a book. For example, the purchase history DB 2001 stores, for each customer, customer identification information and book identification information of a book purchased by the customer in association with each other. The customer identification information is not particularly limited as long as the customer can be uniquely specified. The book identification information is not particularly limited as long as the book can be uniquely specified.

The reservation DB 2002 stores each reservation of the store. For example, the reservation DB 2002 stores a reservation date, a reservation time, customer identification information of a reserved customer, and the like for each reservation. The reservation time may be a reservation start time and time, or a time zone such as a reservation start time to a reservation end time.

The customer DB 2003 stores customer information. The customer DB 2003 stores customer identification information of a customer and customer information for each customer. The customer information is information such as a schedule of the customer, a progress status of each book by the customer, and the time of reading at a place other than the store. The progress status for each book may be, for example, either the remaining number of pages of reading for the book, the number of pages currently read for the book, or the like. The number of pages currently read is also referred to as a current number of pages. The remaining number of pages can be acquired by subtracting the current number of pages from the number of pages of the book. In the second example embodiment, the number of pages of the book is included in the book DB 2004. The time of reading at a place other than the store is, for example, a time of reading at home, and is not particularly limited. For example, the time of reading may also include a frequency, such as twice a week, one hour, etc.

The book DB 2004 stores information of books. The purchase history DB 2001 stores the book identification information and the information of the book in association with each other for each book. The information of the book may be a title of the book, the number of pages of the book, a classification of the book, and the like. The classification of the book is, for example, a classification such as a business book, literature, or a practical book. For example, in the second example embodiment, the classification of the book may be used for the reading speed, and thus, may be a classification that affects the reading speed.

Next, each functional unit will be described.

The acquisition unit 201 acquires the schedule of the customer and the progress status of reading for the book. First, an example of acquiring the progress status of reading will be described. A specific method by which the acquisition unit 201 acquires the progress status of reading of the book is not particularly limited as described in the first example embodiment. For example, in the second example embodiment, the acquisition unit 201 may acquire the progress status of reading from the customer DB 2003. For example, the acquisition unit 201 may receive the progress status of the customer. Here, an example of receiving the progress status of the customer via the terminal device 21 will be described. It is assumed that an application program installed in the terminal device 21 acquires the customer identification information in advance.

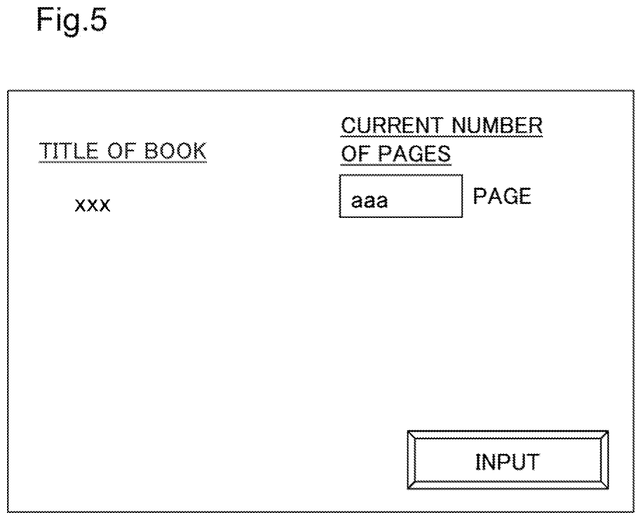

FIG. 5 is an explanatory diagram illustrating an example of a screen for receiving a progress status of reading of a book. For example, the output control unit 203 causes the terminal device 21 to display a screen for receiving the progress status of reading. The terminal device 21 displays a screen for receiving the progress status of reading.

In FIG. 5, the title of the book that the customer is currently reading is displayed on the screen. In FIG. 5, the title of the book is “xxx”. The screen includes an input field in which the current number of pages can be input as the progress status of the book. In FIG. 5, “aaa” is input as the current number of pages in the input field. The screen includes an “input” button. For example, when the “input” button is pressed, the terminal device 21 transmits the number of pages input in the input field to the reservation support system 20. As a result, the acquisition unit 201 can acquire the current number of pages input in the input field. The acquisition unit 201 may acquire the remaining number of pages by subtracting the current number of pages from the number of pages of the book included in the book DB 2004. Then, the acquisition unit 201 may register the remaining number of pages and the current number of pages in the customer DB 2003 as the progress status of reading for the book.

The description returns to FIG. 4. Next, the specification unit 202 specifies the recommended reservation time and candidates for the reservation date of the store based on the progress status of reading.

If the schedule of the customer can be acquired, the recommended reservation time and candidates for the reservation date of the store may be specified using the schedule of the customer. Therefore, for example, the acquisition unit 201 may acquire the schedule of the customer from a database or the like, or may acquire the schedule by receiving an input from the customer. For example, a database stored in a database such as an application program for managing a schedule may be used as the database. Then, the specification unit 202 specifies the recommended reservation time and candidates for the reservation date of the store based on the schedule of the customer and the progress status of reading. For example, regarding the schedule of the customer, the acquisition unit 201 acquires the schedule of the customer.

Further, the customer may also read at a place other than the store. The place other than the store is a house, a train, or the like. Therefore, for example, the specification unit 202 may specify the recommended reservation time and candidates for the reservation date of the store based on the schedule of the customer, the progress status of reading, and the time of reading at a place other than the store.

Next, an example in which the candidates for the reservation date and the recommended reservation time are specified will be described in detail. The order in which the candidates for the reservation date and the recommended reservation time are specified is not particularly limited. The specification unit 202 may specify the candidates for the reservation date and the recommended reservation time by optimizing the combination of the candidates for the reservation date and the recommended reservation time.

Here, first, a case where candidates for a reservation date are specified after the recommended reservation time of the store is specified will be described as an example. As described in the first example embodiment, for example, the specification unit 202 specifies the recommended reservation time of the store based on the progress status of reading.

As described in the first example embodiment, for example, the specification unit 202 may specify the reading finish time of the book based on the remaining number of pages and the reading speed.

Here, the expression form of the reading speed is not particularly limited as long as the reading finish time can be specified by the remaining number of pages and the reading speed. The reading speed may be the time of reading per page, may be the number of pages per unit time, or may be the number of pages read by one reading, or may be the time taken for one reading. For example, the reading speed is described by taking the time of reading per page as an example.

For example, the reading speed may be a predetermined speed determined in advance. For example, the reading speed may be defined in a plurality of stages such as fast, slow, and normal. Then, for example, a speed selected by the customer from a plurality of speeds such as a high speed, a low speed, and a normal speed may be used to specify the reading finish time. The method of selecting the speed by the customer may be performed, for example, via the terminal device 21.

Alternatively, for example, the reading speed may be a speed specified based on the customer's past store reservation time and the number of pages the book was read at that time. The reading speed is optimized for each customer, and the specific accuracy of the reading finish time can be improved.

Alternatively, for example, it is assumed that the reading speed varies depending on the type of books such as business books and literature. Therefore, the reading speed may be determined in advance for each type of book. Specifically, for example, the reading speed may be tabulated in advance for each type of book. Then, for the current book, the specification unit 202 specifies the type of book associated with the book identification information of the current book from the book DB 2004, and specifies the reading speed related to the specified type of the book from the table. Then, the specification unit 202 specifies the reading finish time of the book based on the specified reading speed and the remaining number of pages. Since the reading speed is used for each book, the specific accuracy of the reading finish time can be improved.

The reading speed for each type of book, the reading speed for each customer, and the reading speed selected from a plurality of categorized reading speeds may be combined. The specification unit 202 may specify a new reading speed based on the reading speed for each type of book and the reading speed for each customer, and use the new reading speed for specifying the reading finish time. The specification unit 202 may select any one speed from a reading speed for each type of book, a reading speed for each customer, a reading speed selected from a plurality of categorized reading speeds, and the like, and use the selected speed for specifying the reading finish time. The specification unit 202 may calculate a statistical reading speed from these reading speeds and use the calculated reading speed for specifying the reading finish time.

Returning to the description of the method of specifying the recommended reservation time, for example, the specification unit 202 specifies the recommended reservation time based on the reading finish time. An example in which the specification unit 202 specifies the recommended reservation time based on the reading finish time is as described in the first example embodiment.

In a case where the time when the customer reads a book at a place other than the store is used, for example, the specification unit 202 may specify the recommended reservation time based on the time when the customer reads a book at a place other than the store and the reading finish time. For example, the specification unit 202 may specify the recommended reservation time based on a time obtained by subtracting the time of reading at a place other than the store included in the customer DB 2003 from the reading finish time. For example, the reservation support system 20 may specify the subtracted time as the recommended reservation time.

Here, the time of reading at a place other than the store may be defined in detail or may not be strict. Therefore, for example, the specification unit 202 may specify the recommended reservation time based on the presence or absence of reading at a place other than the store and the reading finish time. For example, in a case where there is reading at a place other than a store, the time of reading at the place other than the store may be set as a predetermined time, and the specification unit 202 may specify the recommended reservation time based on a time obtained by subtracting the predetermined time from the reading finish time. On the other hand, for example, in a case where there is no reading at a place other than the store, the specification unit 202 may specify the recommended reservation time based on the reading finish time.

As a method of specifying the recommended reservation time, for example, the specification unit 202 may specify the recommended reservation time based on the reservation time and the reading finish time in the past. Specifically, for example, the specification unit 202 may specify a shorter one of the reservation time and the reading finish time in the past as the recommended reservation time. Alternatively, the specification unit 202 may specify the longer one of the reservation time and the reading finish time in the past as the recommended reservation time.

Then, for example, the specification unit 202 specifies candidates for a reservation date on which at least the recommended reservation time can be reserved based on the schedule of the customer and the reservation status of the store. In the second example embodiment, the reservation status of the store is included in the reservation DB 2002. For example, the specification unit 202 specifies, as candidates for the reservation date, a date on which there is no schedule for the recommended reservation time in the schedule of the customer and the recommended reservation time can be reserved from the reservation status of the store.

As a method of specifying candidates for a reservation date, the specification unit 202 may specify, as candidates for a reservation date, a date closest to the present among dates for which there is no schedule for the recommended reservation time and for which the recommended reservation time can be reserved from the reservation status of the store. The specification unit 202 may specify a predetermined number of candidates for the reservation date in the order of the date closest to the present among dates for which there is no schedule for a time longer by a predetermined time than the recommended reservation time and for which the recommended reservation time can be reserved from the reservation status of the store. Alternatively, for example, the specification unit 202 may specify candidates for a reservation date within a predetermined number of days from the present.

Next, a case where the recommended reservation time is specified after the candidates for the reservation date of the store are specified will be described as an example. First, for example, the specification unit 202 specifies candidates for the reservation date based on the schedule of the customer and the reservation status of the store. As a method of specifying candidates for a reservation date, for example, the specification unit 202 specifies a date on which there is a free time in the schedule of the customer and which can be reserved from the reservation status of the store as candidates for a reservation date. Then, for example, the specification unit 202 may specify the recommended reservation time that can be reserved on the reservation date based on the schedule of the customer and the progress status of reading. For example, the specification unit 202 specifies the reading finish time of the book based on the remaining number of pages which is the progress status of reading and the reading speed. The process of specifying the reading finish time is as described above. Then, for example, the specification unit 202 may specify the reading finish time as the recommended reservation time.

For example, the specification unit 202 may specify the reservation-available start time on the reservation date based on the reservation status of the store together with the recommended reservation time. The reservation-available start time is, for example, “from 13:00”. Based on the reservation-available start time and the recommended reservation time, the specification unit 202 can specify the reservation-available time zone from the reservation-available start time to the reservation-available end time.

The specification unit 202 may specify the recommended reservation time based on the time of reading and the reading finish time at a place other than the store. For example, the specification unit 202 specifies the time of reading at a place other than the store from the present to the candidates for the reservation date of the store based on the time of reading at a place other than the store included in the customer DB 2003. Then, for example, the specification unit 202 may specify the recommended reservation time based on a time obtained by subtracting the specified time of reading from the reading finish time. For example, the specification unit 202 may specify the subtracted time as the recommended reservation time.

Next, the output control unit 203 presents the specified candidates for the reservation date and the recommended reservation time to the customer. A specific example of presenting the candidates for the reservation date and the recommended reservation time is as described in the first example embodiment.

The output control unit 203 may present a reservation-available time zone. In a case where the reservation-available time zone is displayed, the output control unit 203 may present both the recommended reservation time and the reservation-available time zone. Since the customer can estimate the recommended reservation time if the reservation-available time zone is presented, the output control unit 203 may present the reservation-available time zone as the recommended reservation time.

The accepting unit 204 accepts designation of a reservation date and a reservation time. A specific reception method is as described in the first example embodiment. Specifically, the accepting unit 204 accepts designation of the reservation date and the reservation time from the candidates for the reservation date and the recommended reservation time. More specifically, for example, the accepting unit 204 may select the reservation date from candidates for the reservation date. For example, the accepting unit 204 may accept the recommended reservation time as the reservation time.

Here, an example will be described in which candidates for a reservation date, a recommended reservation time, and a reservation-available time zone are presented via the terminal device 21, and the reservation date and the reservation time are accepted.

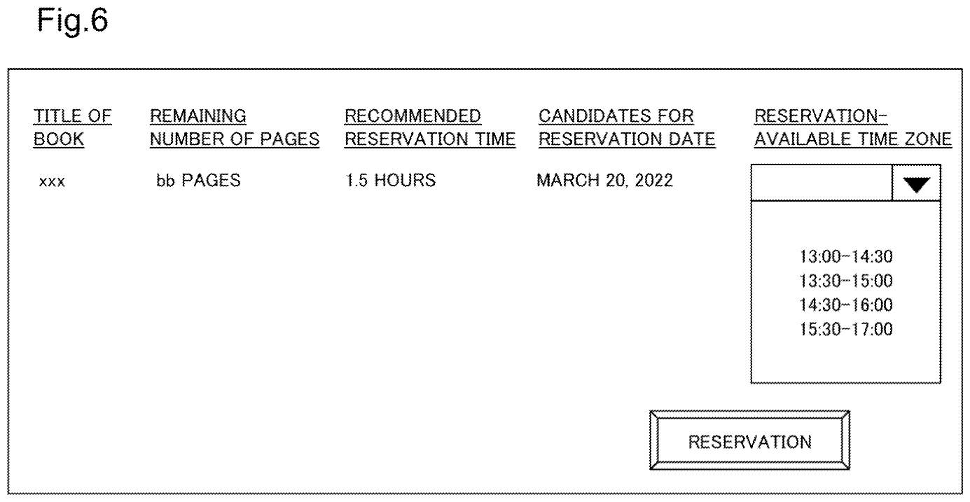

FIG. 6 is an explanatory diagram illustrating an example in which a recommended reservation time and candidates for a reservation date are presented and the reservation date and the reservation time are accepted. The output control unit 203 causes the terminal device 21 to display a screen including the title of the book, the remaining number of pages, the recommended reservation time, the candidates for the reservation date, and the reservation-available time zone, and capable of receiving the reservation. In FIG. 6, for example, the reservation time can be selected from the reservation-available time zone.

In FIG. 6, the screen includes, for example, a “reservation” button. When the “reservation” button is pressed, the accepting unit 204 accepts candidates for a reservation date as a reservation date, and accepts a time zone selected from the reservation-available time zones as a reservation time.

In FIG. 6, for easy understanding, an example has been described in which a candidate for a reservation date is clearly indicated as “candidates for a reservation date” on the screen, and when the “reservation” button is pressed, the accepting unit 204 accepts the candidates for the reservation date as the reservation date. However, the present disclosure is not limited to this example. For example, a reservation date can be selected on the screen, and candidates for the reservation date may be displayed in a selected state as the reservation date. In such a case, for example, if the reservation date is not changed by the operation of the customer, the accepting unit 204 accepts candidates for the reservation date as the reservation date. In such a case, for example, the screen may be displayed in a state where a reservation date can be selected on the calendar and candidates for the reservation date is selected on the calendar.

When a reservation date different from the candidates for the reservation date is selected, the specification unit 202 specifies the reservation-available time zone based on the recommended reservation time and the reservation status of the selected reservation date. Then, the output control unit 203 displays the reservation-available time zone again. Then, the accepting unit 204 may accept a time zone selected from the reservation-available time zone as the reservation time.

The description returns to FIG. 4. Here, for example, in a case where the reading finish time is long, the remaining pages may be read divided into a plurality of days. The specification unit 202 may specify the recommended reservation days when the reading finish time is long. Specifically, for example, in a case where the reading finish time is equal to or more than a predetermined time, the specification unit 202 may specify the recommended reservation days. Alternatively, for example, the specification unit 202 may specify the recommended reservation days in a case where the reading finish time is equal to or more than the past reservation time by a predetermined time. As a method of specifying the recommended reservation days, for example, the specification unit 202 may specify the recommended reservation days based on the number of solutions obtained by dividing the reading finish time by a specific time. For example, the specification unit 202 may specify the number of solutions obtained by dividing the reading finish time by a specific time as the recommended reservation days. In a case where there is a remainder when the reading finish time is divided by a specific time, the specification unit 202 may specify a number obtained by adding 1 to the number of solutions as the recommended reservation days. The specific time is not particularly limited, but may be determined by, for example, a past reservation time by the customer. Specifically, for example, the specific time may be a statistical value of a past reservation time. Alternatively, for example, the specific time may be a predetermined time used for determining whether the reading finish time is long. For example, in a case where the reading finish time is equal to or more than a predetermined time, the specification unit 202 may specify a number obtained by dividing the reading finish time by a predetermined time as the recommended reservation days.

Then, the output control unit 203 presents the recommended reservation days.

The specification unit 202 specifies a plurality of candidates for the reservation dates based on the schedule of the customer, the recommended reservation days, and the reservation status of the store. For example, the specification unit 202 may specify candidates for the reservation date corresponding to at least the recommended reservation days. As a specific example, in a case where the predetermined time is 1.5 hours and the reading finish time is 4.5 hours, the specification unit 202 specifies 3 as the recommended reservation days. Then, the specification unit 202 may specify candidates for the reservation date corresponding to at least the recommended reservation days based on the schedule of the customer, the recommended reservation days, and the reservation status of the store.

The specification unit 202 specifies the recommended reservation time based on the recommended reservation days. For example, in a case where the predetermined time used for determining whether the reading finish time is long is 1.5 hours and the reading finish time is 4.5 hours, the specification unit 202 specifies 3 as the recommended reservation days. Then, the specification unit 202 may specify the recommended reservation time as 1.5 hours. For example, in a case where the predetermined time is 1.5 hours and the reading finish time is 5 hours, the specification unit 202 specifies 4 as the recommended reservation days. Then, the specification unit 202 may specify the recommended reservation time for three days among the recommended reservation days as 1.5 hours, and may specify the recommended reservation time for one day as 0.5 hours. Alternatively, the specification unit 202 may specify a time obtained by dividing the reading finish time by the recommended reservation days as each recommended reservation time, and specify the recommended reservation time for one day as 0.5 hours.

When both the plurality of candidates for the reservation dates and the recommended reservation time of each candidate are specified, the specific order is not particularly limited as described above. For example, in a case where candidates for the reservation date are specified after the recommended reservation time is specified, the specification unit 202 may specify the reservation date on which each recommended reservation time can be reserved based on the schedule of the customer and the reservation status of the store. The specification unit 202 may specify the reservation-available time zone based on the recommended reservation time for each candidate for the reservation date. The method of specifying the reservation-available time zone is as described above.

Then, the output control unit 203 presents a plurality of specified candidates for the reservation date and the recommended reservation time.

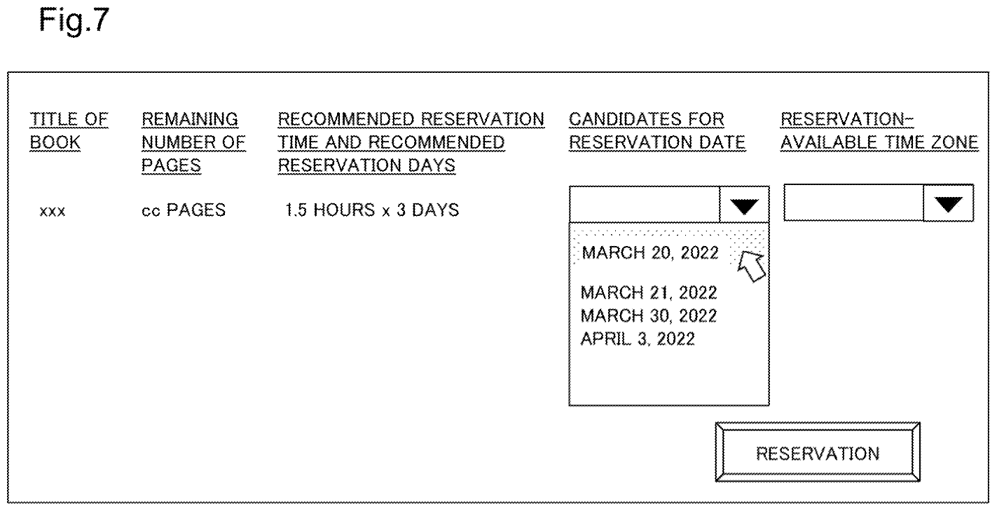

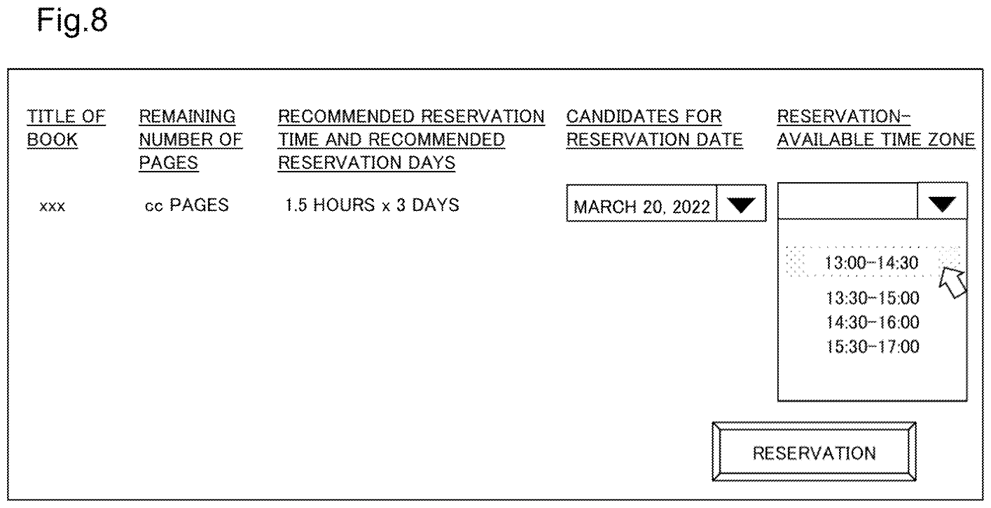

Here, an example of presentation of the recommended reservation time, the recommended reservation days, and a plurality of candidates for the reservation date will be described with reference to FIGS. 7 and 8.

FIG. 7 is an explanatory diagram illustrating an example of presentation of the recommended reservation time, the recommended reservation days, and a plurality of candidates for the reservation date. The output control unit 203 causes the terminal device 21 to display a screen including the title of the book, the remaining number of pages, the recommended reservation time and the recommended reservation days, a plurality of candidates for the reservation date, and the reservation-available time zone, the screen being capable of accepting the reservation. In FIG. 7, the screen includes, for example, a “reservation” button.

For example, in FIG. 7, it is possible to select a reservation date from a plurality of candidates for the reservation date on the screen. For example, when a reservation date is selected from a plurality of candidates for reservation date, the output control unit 203 displays a reservation-available time zone in the reservation. In FIG. 7, the reservation date “Mar. 20, 2022” is selected.

FIG. 8 is an explanatory diagram illustrating an example of presentation of the reservation-available time zone of the reservation date selected from a plurality of candidates for the reservation date. The configuration of the screen in FIG. 8 is the same as the configuration of the screen in FIG. 7. In FIG. 8, a reservation-available time zone for the selected reservation date “Mar. 20, 2022” is displayed on the screen. In FIG. 8, for example, the reservation time can be selected from the reservation-available time zone.

In FIG. 8, the screen includes, for example, a “reservation” button. When the “reservation” button is pressed, the accepting unit 204 accepts the selected reservation date and a time zone selected from the reservation-available time zone as the reservation time.

The accepting unit 204 may simultaneously accept reservations for a plurality of recommended reservation days, or may accept reservations at different timings.

The description returns to FIG. 4. It is assumed that the next book is read after the current book is read. Therefore, the specification unit 202 specifies candidates for a reservation date and a recommended reservation time for reading the next book after the customer reads the book based on the purchase history of the customer. Specifically, the specification unit 202 specifies an unread book among the books purchased by the customer as the next book based on the purchase history DB 2001 and the customer DB 2003. The acquisition unit 201 acquires the number of pages of the next book from the book DB 2004 or the like. Then, the specification unit 202 specifies the reading finish time of the next book based on the number of pages of the next book. The specification unit 202 specifies candidates for a reservation date and a recommended reservation time for reading the next book based on the reading finish time of the next book and the schedule of the customer. Then, the output control unit 203 presents the candidates for the reservation date and the recommended reservation time. As described above, the number of candidates for the reservation date may be plural.

Alternatively, in a case where the book is included in a plurality of volumes, the specification unit 202 specifies candidates for a reservation date and a recommended reservation time for reading the next book that is the next volume of the book. Specifically, for example, the specification unit 202 specifies whether a book is included in a plurality of volumes based on the book DB 2004, and specifies the next volume of the book as the next book when the book is included in the plurality of volumes. Then, the acquisition unit 201 acquires the number of pages of the next book from the book DB 2004 or the like. Then, the specification unit 202 specifies candidates for a reservation date and a recommended reservation time for reading the next book based on the number of pages of the next book. The output control unit 203 presents candidates for a reservation date and a recommended reservation time for reading the next book.

Here, the specification unit 202 may add up the reading finish time of the next book and the reading finish time of the current book, and specify the recommended reservation time based on the total reading finish time. For example, the specification unit 202 may specify a candidate for the reservation date by combining the next book and the current book.

For example, the specification unit 202 may specify the recommended reservation time for each of the next book and the current book. For example, the specification unit 202 may specify candidates for the reservation date for each of the next book and the current book.

The reservation confirmation unit 205 confirms the accepted reservation. For example, the reservation confirmation unit 205 registers the reservation in the reservation DB 2002 as the processing of fixing the reservation.

Then, when the reservation is confirmed, the output control unit 203 notifies the customer of the confirmed reservation. The output control unit 203 may notify the previously confirmed reservation together with the currently confirmed reservation. As a notification method, the output control unit 203 may make a notification via at least one of an electronic mail, an electronic message, or the like. Alternatively, as a notification method, the output control unit 203 may output to the terminal device 21 via an application program for managing reservation. The output method is not particularly limited, and examples thereof include display on a display device and sound output to a voice output device.

When the reservation is confirmed, the update unit 206 may update various thresholds such as various DBs and a predetermined time.

When the reservation is fulfilled, the update unit 206 may update various thresholds such as various DBs and a predetermined time. The fact that the reservation is fulfilled indicates that the customer visits the store as reserved and reads. For example, in a case where the reading speed for each customer is used to specify the reading finish time, the update unit 206 may update the reading speed for each customer based on the actual use time of the store and the progress status of reading.

(Flowchart)

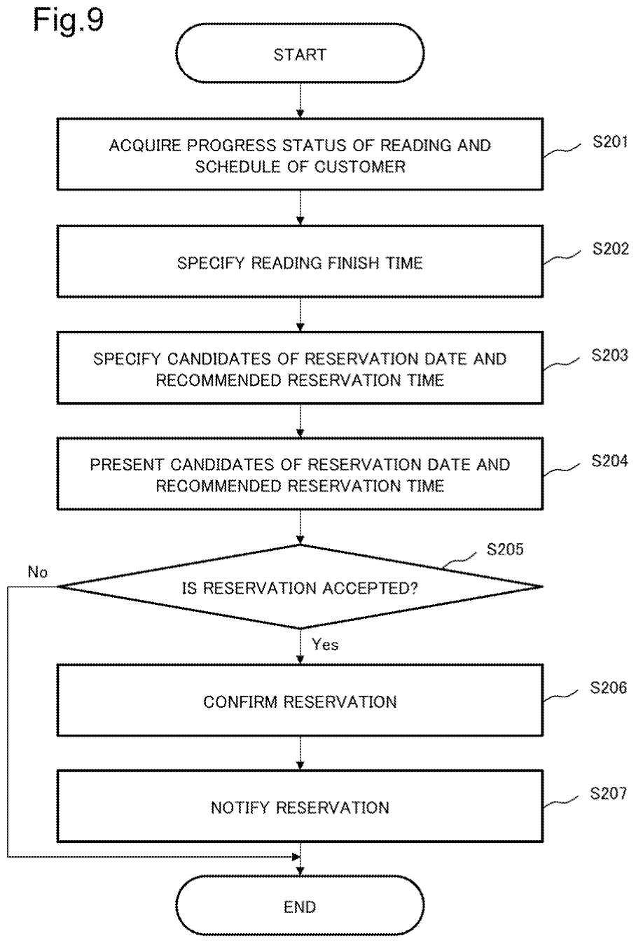

FIG. 9 is a flowchart illustrating an operation example of the reservation support system 20 according to the second example embodiment. The acquisition unit 201 acquires the progress status of reading and the schedule of the customer (step S201). The specification unit 202 specifies the reading finish time based on the progress status of reading (step S202). Next, the specification unit 202 specifies candidates for a reservation date and a recommended reservation time based on the reading finish time and the schedule of the customer (step S203).

The output control unit 203 presents candidates for a reservation date and a recommended reservation time (step S204). The accepting unit 204 determines whether a reservation has been accepted (step S205). When the reservation is accepted (step S205: Yes), the reservation confirmation unit 205 confirms the reservation (step S206). Then, the output control unit 203 notifies the customer of the confirmed reservation (step S207), and the reservation support system 20 ends the processing. In a case where the reservation has not been accepted (step S205: No), the reservation support system 20 ends the processing.

As described above, in the second example embodiment, when the reading finish time is equal to or more than the predetermined time, the reservation support system 20 specifies the recommended reservation days and presents the recommended reservation days. As a result, the customer can confirm the number of days of reservation required to finish reading at the store. Therefore, it is possible to further facilitate determination of reservation.

For example, the reading speed may be at least one of a predetermined reading speed, a reading speed specified based on the past reservation time by the customer and the progress status of reading at the past reservation time, and a reading speed related to the type of book. This makes it possible to more accurately specify the reading finish time. Alternatively, the reading speed may be a reading speed specified by at least one of a predetermined speed, a reading speed specified based on a past reservation time by the customer and a progress status of reading in the past reservation time, and a reading speed related to a book type.

For example, the reservation support system 20 specifies the recommended reservation time based on the time when the customer reads at a place other than the store and the reading finish time. Consequently, the specific accuracy of the recommended reservation time can be improved.

The reservation support system 20 acquires the schedule of the customer, specifies the recommended reservation time and the candidates for the reservation date based on the schedule and the progress status, and presents the specified candidates for the reservation date and the recommended reservation time to the customer. The reservation support system 20 accepts the reservation based on the candidate for the reservation date and the recommended reservation time. This makes it possible to more accurately specify the candidates for the reservation date and the recommended reservation time.

The reservation support system 20 specifies candidates for a reservation date and a recommended reservation time for reading the next book after the customer reads the book based on the purchase history of the customer. The reservation support system 20 presents the candidates for the reservation dates and the recommended reservation time for reading the next book. Accordingly, it is possible to facilitate reservation of reading for a book that is estimated to be newly read by a customer. Therefore, the use of the store can be promoted.

In a case where the book is included in a plurality of volumes, the reservation support system 20 specifies candidates for a reservation date and a recommended reservation time for reading the next book which is the next volume of the book. The reservation support system 20 presents the candidates for the reservation dates and the recommended reservation time for reading the next book. Accordingly, it is possible to facilitate reservation of reading for a book that is estimated to be newly read by a customer. Therefore, the use of the store can be promoted.

When the recommended reservation days are specified, the reservation support system 20 acquires the schedule of the customer, and specifies the plurality of candidates for the reservation date and the recommended reservation time of each of the plurality of candidates for the reservation date based on the schedule, the progress status, and the recommended reservation days. Then, the reservation support system 20 presents the plurality of specified candidates for the reservation date and the recommended reservation time. As a result, the customer can confirm the candidates for the reservation date and the number of recommended reservation times required to finish reading at the store. Therefore, it is possible to more easily determine the reservation.

For example, in the second example embodiment, the output control unit 203 may present at least one of the recommended reservation time and the candidates for the reservation date. However, in a case where the customer has not determined the reservation date, when the output control unit 203 presents both the candidates for the reservation date and the recommended reservation time, the customer can confirm both. Therefore, it is possible to more easily determine the reservation.

The description of each example embodiment is ended. Each example embodiment may be modified and used.

<Modification>

In each example embodiment, for example, an example in which the output control unit 203 presents the recommended reservation time, the candidates for the reservation date, and the like has been described, but the reading finish time may be presented. The customer may not know how long it takes to finish reading for the book.

Therefore, the acquisition unit 201 acquires the progress status of reading for the book. The specification unit 202 specifies the reading finish time of the book based on the progress status of reading of the book. Then, the output control unit 203 presents the reading finish time of the book. This allows the customer to know the time required to read the book currently read. In this manner, it is possible to support completion of reading of the book. Motivation for reading for the book can be improved. As described above, each functional unit in each example embodiment may be configured as a reading support system including the acquisition unit 201, the specification unit 202, and the output control unit 203.

The description of the modification is ended. Each example embodiment and each modification may be used in appropriate combination. In each example embodiment, the reservation support systems 10 and 20 may be configured to include each functional unit and a part of information, or may be configured to include other functional units (not illustrated).

Each example embodiment and each modification are not limited to the above-described examples, and various modifications can be made. The configurations of the reservation support systems 10 and 20 in the example embodiments are not particularly limited. For example, the reservation support system may be achieved by one device such as one terminal device and one server. In a case where each functional unit of the reservation support systems 10 and 20 is achieved by one device, for example, one device may be referred to as a reservation support device, an information processing device, or the like, and is not particularly limited. Alternatively, the reservation support system in each example embodiment may be achieved by different devices for each function or data. For example, each functional unit of the reservation support systems 10 and 20 may include a plurality of servers and be implemented as the reservation support systems 10 and 20. For example, the reservation support systems 10 and 20 may be achieved by a database server including each DB and a server including each functional unit.

In each example embodiment, each piece of information or each DB may include a part of the above-described information. Each piece of information or each DB may include information other than the above-described information. Each piece of information or each DB may be divided into a plurality of DBs or a plurality of pieces of information in more detail. A plurality of DBs or a plurality of pieces of information may be achieved by one DB or one piece of information. As described above, a method of implementing each piece of information or each DB is not particularly limited.

Each screen is an example, and is not particularly limited. In each screen, a button, a list, a check box, an information display field, an input field, and the like (not illustrated) may be added. The background color of the screen and the like may be changed.

For example, in each example embodiment, the processing of generating information or the like of a screen to be displayed on the terminal device 21 may be performed by the output control units 103 and 203 of the reservation support systems 10 and 20. For example, this processing may be performed by the terminal device 21.

(Exemplary Hardware Configuration of Computer)

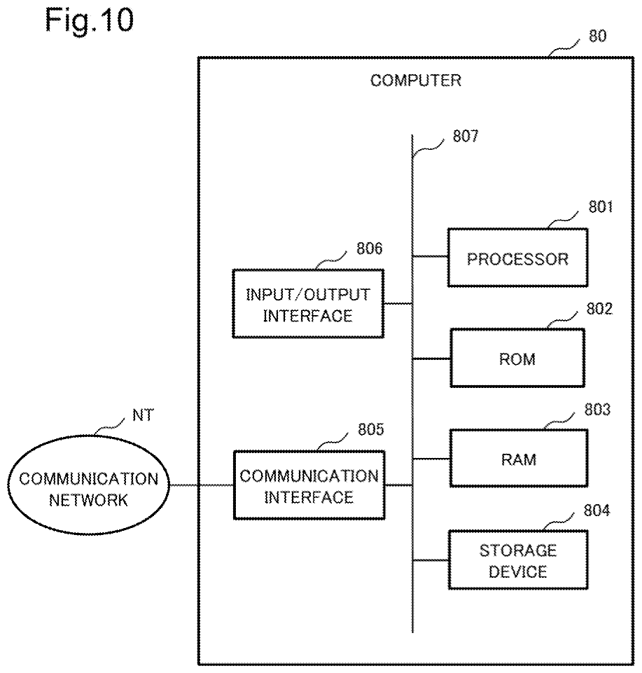

Next, an exemplary hardware configuration in a case where each device such as the reservation support systems 10 and 20 and the terminal device 21 described in each example embodiment is achieved by a computer will be described. FIG. 10 is an explanatory diagram illustrating an exemplary hardware configuration of a computer. For example, some or all of the devices can be achieved by using an arbitrary combination of a computer 80 and a program as illustrated in FIG. 10.

The computer 80 includes, for example, a processor 801, a read only memory (ROM) 802, a random access memory (RAM) 803, and a storage device 804. The computer 80 includes a communication interface 805 and an input/output interface 806. The components are connected via, for example, a bus 807. The number of components is not particularly limited, and each component is one or more.

The processor 801 controls the entire computer 80. Examples of the processor 801 include a central processing unit (CPU), a digital signal processor (DSP), and a graphics processing unit (GPU). The computer 80 includes a ROM 802, a RAM 803, a storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. Then, the RAM 803 is used as a work area of the processor 801.

The processor 801 loads a program stored in the storage device 804, the ROM 802, or the like. Then, the processor 801 executes each process coded in the program. The processor 801 may download various programs via the communication network NT. The processor 801 functions as a part or all of the computer 80. Then, the processor 801 may execute processing or instructions in the illustrated flowchart based on the program.

The communication interface 805 is connected to a communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. Then, the communication interface 805 controls input and output of data from an external device or the external computer 80.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and a voice output device that outputs voice. Examples of the input/output device include a touch panel display. The input device, the output device, the input/output device, and the like may be built in the computer 80 or may be externally attached.

The hardware configuration of the computer 80 is an example. The computer may have some components illustrated in FIG. 10. The computer 80 may have components other than those illustrated in FIG. 10. For example, the computer 80 may include a drive device or the like. Then, the processor 801 may read a program or data stored in a recording medium attached to a drive device or the like into the RAM 803. Examples of the non-transitory tangible recording medium include an optical disk, a flexible disk, a magnetic optical disk, and a universal serial bus (USB) memory. As described above, for example, the computer 80 may include an input device such as a keyboard and a mouse. The computer 80 may have an output device such as a display. The computer 80 may include an input device, an output device, and an input/output device.

The computer 80 may include various sensors (not illustrated). The type of the sensor is not particularly limited. The computer 80 may include an imaging device capable of capturing images and videos.

This is the end of the description of the hardware configuration of each device. There are various modifications of the method of achieving each device. For example, each device may be achieved by an arbitrary combination of a computer and a program different for each component. A plurality of components included in each device may be realized by an arbitrary combination of one computer and a program.

A part or all of each component of each device may be achieved by an application specific circuit. A part or all of each component of each device may be achieved by a general-purpose circuit including a processor such as a field programmable gate array (FPGA). A part or all of each component of each device may be achieved by a combination of an application specific circuit, a general-purpose circuit, or the like. These circuits may be a single integrated circuit. Alternatively, these circuits may be divided into a plurality of integrated circuits. The plurality of integrated circuits may be configured by being connected via a bus or the like.

In a case where a part or all of each component of each device is achieved by a plurality of computers, circuits, and the like, the plurality of computers, circuits, and the like may be arranged in a centralized manner or in a distributed manner.

The reservation support method described in each example embodiment is achieved by the reservation support system. For example, the reservation support method is achieved by a computer such as a server or a terminal device executing a program prepared in advance. The program described in each example embodiment is recorded in a computer-readable recording medium such as an HDD, an SSD, a flexible disk, an optical disk, a magnetic optical disk, and a USB memory. Then, the program is executed by being read from the recording medium by the computer. The program may be distributed via the communication network NT.

Each component of the reservation support system in each example embodiment described above may be achieved by dedicated hardware such as a computer. Alternatively, each component may be achieved by software. Alternatively, each component may be achieved by a combination of hardware and software.

Although the present disclosure has been particularly shown and described with reference to the present example embodiment, the present disclosure is not limited to the above example embodiment.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

For example, the matters described using a specific example embodiment can be applied to other example embodiments as long as no contradiction occurs. For example, although the plurality of operations are described in order in the form of a flowchart, the order of description does not limit the order of executing the plurality of operations.

Therefore, when each example embodiment is implemented, the order of the plurality of operations can be changed within a range that does not interfere with the content.

Further, it is noted that the inventor's intent is to retain all equivalents of the claimed invention even if the claims are amended during prosecution.

### SUPPLEMENTARY NOTE

A part or all of the above example embodiments can also be described as the following supplementary notes. However, a part or all of the above example embodiments are not limited to the following.

(Supplementary Note 1)

A reservation support system including:
an acquisition means configured to acquire a progress status of reading by a user for a book;
a specification means configured to specify a recommended reservation time of a facility based on the progress status;
an output control means configured to present the specified recommended reservation time to the user; and
an accepting means configured to accept a reservation.

(Supplementary Note 2)

The reservation support system according to Supplementary Note 1, in which
the specification means is configured to:
specify a reading finish time of the book based on the progress status and a reading speed; and
specify the recommended reservation time based on the reading finish time.

(Supplementary Note 3)

The reservation support system according to Supplementary Note 2, in which
the specification means is configured to specify recommended reservation days when the reading finish time is equal to or more than a predetermined time, and
the output control means presents the recommended reservation days.

(Supplementary Note 4)

The reservation support system according to Supplementary Note 2 or 3, in which
the speed is any one of a predetermined speed, a speed specified based on a past reservation time by the user and a progress status of reading in the past reservation time, and a speed according to a type of the book.

(Supplementary Note 5)

The reservation support system according to any one of Supplementary Notes 2 to 4, in which
the specification means is configured to specify the recommended reservation time based on a time when the user performs the reading at a place other than the facility and the reading finish time.

(Supplementary Note 6)

The reservation support system according to any one of Supplementary Notes 1 to 4, in which
the progress status includes a remaining number of pages of the reading for the book.

(Supplementary Note 7)

The reservation support system according to any one of Supplementary Notes 1 to 6, in which
the acquisition means is configured to acquire a schedule of the user,
the specification means is configured to specify the recommended reservation time and candidates for a reservation date based on the schedule and the progress status,
the output control means is configured to present the specified candidates for the reservation date and the recommended reservation time to the user, and
the accepting means is configured to accept the reservation based on the candidates for the reservation date and the recommended reservation time.

(Supplementary Note 8)

The reservation support system according to Supplementary Note 7, in which
the specification means is configured to specify candidates for a reservation date and a recommended reservation time for reading a next book after the user has read the book based on a purchase history of the user, and
the output control means is configured to present the candidates for the reservation date and the recommended reservation time for reading the next book.

(Supplementary Note 9)

The reservation support system according to Supplementary Note 7, in which
when the book is included in a plurality of volumes, the specification means is configured to specify candidates for a reservation date and a recommended reservation time for reading a next book that is a next volume of the book, and
the output control means is configured to present the candidates for the reservation date and the recommended reservation time for reading the next book.

(Supplementary Note 10)

The reservation support system according to any one of Supplementary Notes 7 to 9, in which
the specification means is configured to:
specify a reading finish time of the book based on the progress status and a reading speed; and
specify the candidates for the reservation date and the recommended reservation time based on the reading finish time.

(Supplementary Note 11)

The reservation support system according to Supplementary Note 10, in which
the specification means is configured to specify the candidates for the reservation date and the recommended reservation time based on a time when the user reads the book at a place other than the facility and the reading finish time.

(Supplementary Note 12)

The reservation support system according to any one of Supplementary Notes 1 to 11, in which
the accepting means is configured to accept a reservation including the recommended reservation time as a reservation time.

(Supplementary Note 13)

The reservation support system according to any one of Supplementary Notes 1 to 11, in which
the accepting means is configured to accept a reservation including a recommended reservation time selected from the recommended reservation time as a reservation time.

(Supplementary Note 14)

The reservation support system according to any one of Supplementary Notes 1 to 11, in which
the accepting means is configured to accept a reservation including an input reservation time.

(Supplementary Note 15)

A reservation support method including:
acquiring a progress status of reading by a user for a book;
specifying a recommended reservation time of a facility based on the progress status;
presenting the specified recommended reservation time to the user; and
accepting a reservation.

(Supplementary Note 16)

A program for causing a computer to execute:
acquiring a progress status of reading by a user for a book;
specifying a recommended reservation time of a facility based on the progress status;
presenting the specified recommended reservation time to the user; and
accepting a reservation.

(Supplementary Note 17)

A non-transitory computer-readable recording medium that records a program for causing a computer to execute:
acquiring a progress status of reading by a user for a book;
specifying a recommended reservation time of a facility based on the progress status;
presenting the specified recommended reservation time to the user; and
accepting a reservation.

1. A reservation support system comprising:
a memory storing instructions; and
one or more processors configured to execute the instructions to:
acquire a progress status of reading by a user for a book;
specify a recommended reservation time of a facility based on the progress status;
present the specified recommended reservation time to the user; and
accept a reservation.

2. The reservation support system according to claim 1, wherein
the one or more processors are further configured to execute the instructions to:
specify a reading finish time of the book based on the progress status and a reading speed; and
specify the recommended reservation time based on the reading finish time.

3. The reservation support system according to claim 2, wherein
the one or more processors are further configured to execute the instructions to:
specify recommended reservation days when the reading finish time is equal to or more than a predetermined time; and
present the recommended reservation days.

4. The reservation support system according to claim 2, wherein
the speed is any one of a predetermined speed, a speed specified based on a past reservation time by the user and a progress status of reading in the past reservation time, and a speed according to a type of the book.

5. The reservation support system according to claim 2, wherein
the one or more processors are further configured to execute the instructions to:
specify the recommended reservation time based on a time when the user performs the reading at a place other than the facility and the reading finish time.

6. The reservation support system according to claim 1, wherein
the progress status includes a remaining number of pages of the reading for the book.

7. The reservation support system according to claim 1, wherein
the one or more processors are further configured to execute the instructions to:
acquire a schedule of the user;
specify the recommended reservation time and candidates for a reservation date based on the schedule and the progress status;
present the specified candidates for the reservation date and the recommended reservation time to the user, and
accept the reservation based on the candidates for the reservation date and the recommended reservation time.

8. The reservation support system according to claim 7, wherein
the one or more processors are further configured to execute the instructions to:
specify candidates for a reservation date and a recommended reservation time for reading a next book after the user has read the book based on a purchase history of the user; and
present the candidates for the reservation date and the recommended reservation time for reading the next book.

9. The reservation support system according to claim 7, wherein
the one or more processors are further configured to execute the instructions to:
when the book is included in a plurality of volumes, specify candidates for a reservation date and a recommended reservation time for reading a next book that is a next volume of the book; and
present the candidates for the reservation date and the recommended reservation time for reading the next book.

10. The reservation support system according to claim 7, wherein
the one or more processors are further configured to execute the instructions to:
specify a reading finish time of the book based on the progress status and a reading speed; and
specify candidates for the candidates for the reservation date and the recommended reservation time based on the reading finish time.

11. The reservation support system according to claim 10, wherein
the one or more processors are further configured to execute the instructions to:
specify the candidates for the reservation date and the recommended reservation time based on a time when the user reads the book at a place other than the facility and the reading finish time.

12. The reservation support system according to claim 1, wherein
the one or more processors are further configured to execute the instructions to:
accept a reservation including the recommended reservation time as a reservation time.

13. The reservation support system according to claim 1, wherein
the one or more processors are further configured to execute the instructions to:
accept a reservation including a recommended reservation time selected from the recommended reservation time as a reservation time.

14. The reservation support system according to claim 1, wherein
the one or more processors are further configured to execute the instructions to:
accept a reservation including an input reservation time.

15. A reservation support method comprising:
acquiring a progress status of reading by a user for a book;
specifying a recommended reservation time of a facility based on the progress status;
presenting the specified recommended reservation time to the user; and
accepting a reservation.

16. A non-transitory computer-readable recording medium that records a program for causing a computer to execute:
acquire a progress status of reading by a user for a book;
specify a recommended reservation time of a facility based on the progress status;
present the specified recommended reservation time to the user; and
accept a reservation.
